(19) United States
(12) Patent Application Publication
(10) Pub. No.: US 2026/0202635 A1
(43) Pub. Date: Jul. 16, 2026

(54) OPTICAL FIBER CABLE EXHIBITING LOW SKEW

(71) Applicant: CORNING RESEARCH & DEVELOPMENT CORPORATION, Corning, NY (US)

(72) Inventors: Victoria Cruickshank, Charlotte, NC (US); Harold Edward Hudson, II, Conover, NC (US); William Carl Hurley, Hickory, NC (US)

(21) Appl. No.: 19/564,541

(22) Filed: Mar. 12, 2026

Related U.S. Application Data
(63) Continuation of application No. PCT/US2024/046539, filed on Sep. 13, 2024.
(60) Provisional application No. 63/538,554, filed on Sep. 15, 2023.

(51) Int. Cl. G02B 6/44

(52) U.S. Cl. CPC G02B 6/4436; G02B 6/4486

(57) ABSTRACT

A fire-retardant, low-skew optical fiber cable for use in datacenters and with small-form-factor optical connectors.

### RELATED APPLICATIONS

This application is a continuation of International Patent Application No. PCT/US2024/046539, filed on Sep. 13, 2024, which claims priority to U.S. Provisional Patent Application No. 63/538,554, filed on Sep. 15, 2023, and entitled “OPTICAL FIBER CABLE EXHIBITING LOW SKEW,” the entirety of which is incorporated herein by reference.

### BACKGROUND

Data centers use tens of thousands of optical connectors for linking switches, servers, and distribution frames to transfer, retrieve and distribute information.

The data transfer rate through the cables continues to increase, but the speed of the transceivers that produce the optical signals is less than the desired data rate. The solution is to use parallel optical transmission links. An example is a 400 Gbps data stream is divided into eight 50 Gbps signals that travel along eight optical fibers. The signals are recombined at the receiver into the original 400 Gbps data stream. The difference in the time of flight of the optical signals in the fibers can affect the ability to recombine the multiple data streams back into the original data stream. The differences in the time of flight on the signals in the optical paths is called skew. FIG. 1 shows a schematic diagram of a simple 100 G parallel optics link to illustrate the concept of skew. The transmitter sends the first four bits of information simultaneously through the four optical fibers with one bit per fiber. Then the next four bits are sent through the fibers. Because of the difference in the time of flight of the optical signals in the fibers, the signals don't arrive at the receiver in the same sequence as initially transmitted. In FIG. 1, lane 2 has the shortest time of flight and lane 3 has the longest. Therefore, the skew is the difference in arrival times between lane 2 and lane 3. The skew within the cable must be less than the limits allowed in the IEEE 802.3 ethernet standard.

### SUMMARY OF THE DISCLOSURE

The following is a brief summary of subject matter that is described in greater detail herein. This summary is not intended to be limiting as to the scope of the claims.

Described herein are technologies relating to fire-retardant, optical fiber cables suitable for indoor use in data centers, capable of meeting burn test requirements of UL 1666, EN 50399, and and UL 1685 standards and skew requirements of IEEE 802.3, and adapted for use with small-form-factor multi-fiber optical connectors.

The above summary presents a simplified summary in order to provide a basic understanding of some aspects of the systems and/or methods discussed herein. This summary is not an extensive overview of the systems and/or methods discussed herein. It is not intended to identify key or critical elements or to delineate the scope of such systems and/or methods. Its sole purpose is to present some concepts in a simplified form as a prelude to the more detailed description that is presented later.

### BRIEF DESCRIPTION OF THE DRAWINGS

The accompanying drawings are included to provide a further understanding, and are incorporated in and constitute a part of this specification. The drawings illustrate one or more embodiments, and together with the description serve to explain principles and operation of the various embodiments.

FIG. 1 depicts a schematic diagram illustrating skew in optical signal transmission;

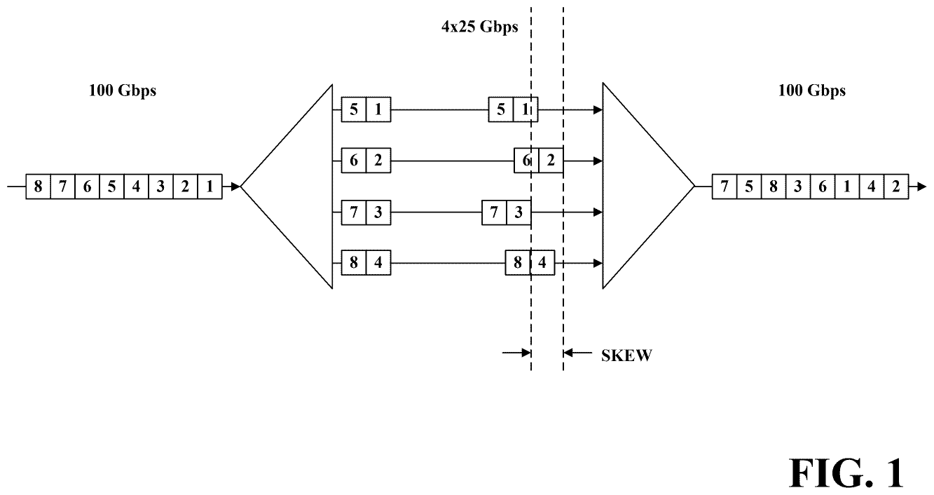

FIG. 2 is a cross-sectional view of an exemplary optical fiber cable.

FIG. 3 is a cross-sectional view of another exemplary optical fiber cable.

FIG. 4 is a depiction of stranding parameters for a buffer tube or optical fiber subunit.

FIG. 5 is an illustration of certain stranding parameters overlaid on a cross-sectional view of the exemplary cable of FIG. 2.

FIG. 6 illustrates experimental results of skew rate measurements between optical fibers of a subunit.

FIG. 7 illustrates experimental results of skew rate measurements for various optical fibers between different subunits of an optical fiber cable.

FIG. 8 is a cross-sectional view of still another exemplary optical fiber cable.

### DETAILED DESCRIPTION

Various technologies pertaining to a fire-retardant, low skew optical fiber cable suitable for use with small-form-factor multi-fiber connectors are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices may be shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or”. That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Additionally, as used herein, the term “exemplary” is intended to mean serving as an illustration or example of something, and is not intended to indicate a preference.

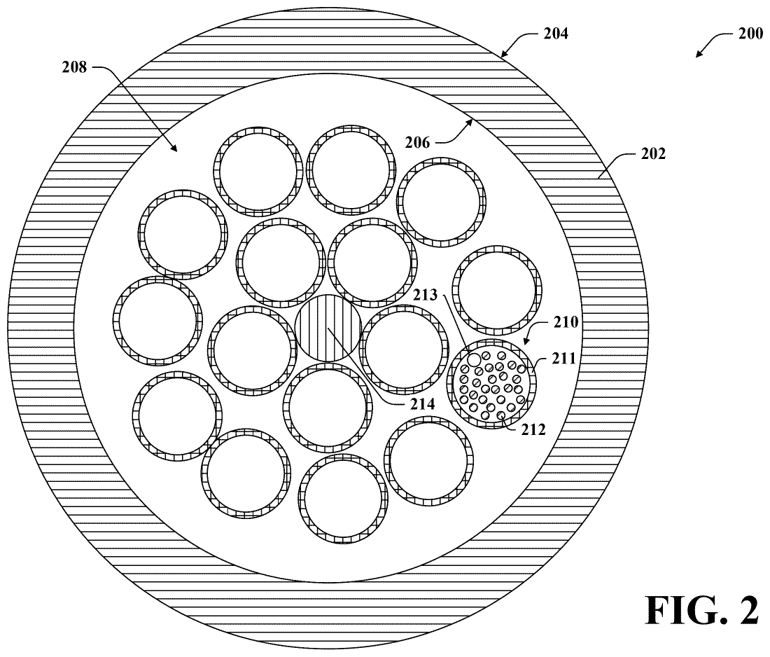

Referring now to FIG. 2, a cross-sectional view of an exemplary optical fiber cable 200 is illustrated. The cable 200 comprises a cable jacket 202 having an outer surface 204 and an inner surface 206. The inner surface 206 defines an interior region 208 that is contained by the cable jacket 202. The cable 200 further comprises a plurality of subunits 210 that are disposed in the interior region 208 within the cable jacket 202. Each of the subunits 210 comprises a respective subunit jacket 211 and a respective plurality of optical fibers 212 disposed within the subunit jacket 211. For simplicity of illustration in FIG. 2, a single plurality of optical fibers 212 is illustrated within a subunit 210. However it is to be understood that each of the subunits 210 contains its own respective plurality of optical fibers 212. The subunits 210 can each further contain one or more tensile yarns 213 disposed within the subunit jacket 211.

The cable 200 can further include a central member 214. In exemplary embodiments, the central member 214 can include tensile yarns such as aramid or fiberglass yarns. In other embodiments, the central member 214 comprises one or more reinforced plastic rods (e.g., glass-reinforced plastic, or GRP, rods). In still other embodiments, the central member 214 comprises water blocking yarns or tapes. In still further embodiments, the central member 214 can be omitted from the cable 200.

The subunits 210 can be stranded about a central axis of the cable 200 (e.g., around the central member 214). Still further, depending upon a number of the subunits 210, the subunits 210 can be stranded in multiple layers. For example, in the exemplary cable 200 the subunits 210 are stranded in two layers: a first layer of five subunits 210 stranded about the central member 214 and a second layer of 11 subunits 210 stranded about the first layer of five subunits 210. In a further exemplary embodiment, the cable 200 can instead include three layers of stranded subunits 210.

The cable jacket 202 can be formed of any of various extrudable materials such as ethylene-vinyl acetate copolymers, ethylene-acrylate copolymers, ethylene homopolymers (including but not limited to low density, medium density, and high density), linear low density polyethylene (LLDPE), very low density polyethylene, polyolefin elastomer copolymer, propylene homopolymer, polyethylene-polypropylene copolymer, butene- and octene branched copolymers, polyester copolymers, polyethylene terephthalates, polybutylene terephthalates, other polymeric terephthalates, and maleic anhydride-grafted versions of the polymers listed herein. In exemplary embodiments, the cable jacket 202 comprises a fire-retardant material such as metal hydrates and metal hydroxides, such as aluminum trihydrate (ATH) and/or magnesium dihydroxide (MDH), borates, and/or other suitable materials that are often referred to as low smoke, zero halogen (LSZH) materials; fire retardant, non-corrosive (FRNC) materials; or fire retardant polyethylene (FRPE) materials.

The cable jacket 202 can be formed of a material that contains one or more fire retardants sufficient in quantity and type to pass the UL 1666, UL 1685 and EN 50399 burn tests. The fire-retardant properties of the material of the cable jacket 202 can be measured in a cone calorimetry test with a heat flux of 50 kW/m². When so tested, the material used to form the cable jacket 202 can be selected to have a peak heat release rate of <240 kW/m², or <200 kW/m². The material used to form the cable jacket 202 can be configured such that the total heat release during cone calorimetry test described above is <70 MJ/m², or <62 MJ/m². The material used to form the cable jacket 202 can be configured such that the total smoke release during the test is <1100 m²/m², or <600 m²/m².

The subunit jackets 211 can be formed from an extruded layer of any of various materials such as, but not limited to, LLDPE or low-density polyethylene (LDPE). In exemplary embodiments, the subunit jackets 211 each have a thickness of less than or equal to 300 microns, or more particularly greater than or equal to 30 microns and less than or equal to 300 microns, or still more particularly greater than or equal to 40 microns and less than or equal to 250 microns. The subunits 210 are sufficiently flexible that the cable jacket 202 and other elements of the cable 200 can be stripped away from a single subunit 210 and the subunit 210 independently routed, such as into a splice tray, to facilitate splicing, connectorization, or other operations with respect to the subunit 210. The subunit jackets 211 can include various fire-retardant fillers such as metal hydroxides and/or borates. Furthermore, the subunit jackets 211 can be formed from LSZH, FRNC, or FRPE materials.

In various embodiments, the subunits 210 are configured to have an outside diameter of between 0.9 mm and 2.6 mm, inclusive, and more particularly between 1.6 mm and 2.3 mm, inclusive, in order to facilitate mating of the subunits 210 with various optical connectors, such as MMC connectors sold by USConec of Hickory, NC. In a particular embodiment, the subunits 210 are configured to have an outside diameter of about 2.0 mm. In exemplary embodiments, the subunits 210 each include 12, 16, 24, 32, or 36 optical fibers. The exemplary cable 200 illustrated in FIG. 2 is configured to include 384 optical fibers 212, 24 in each of 16 subunits 210. However, it is to be appreciated that various other configurations are possible and may be desirable. In a particular embodiment, a cable according to the present disclosure can be configured to have 36 subunits 210 each carrying 24 optical fibers 212, for a total of 864 optical fibers 212. In yet another embodiment, a cable according to the present disclosure can be configured to have, for example, 16 optical fibers 212 in each of the subunits 210.

In exemplary embodiments, the optical fibers 212 can be 200-micron-diameter optical fibers. Acrylate coatings of 250-micron-diameter optical fibers provide substantial fuel loading to an optical fiber cable, which limits burn performance. The 200-micron-diameter optical fibers used for the optical fibers 212 of the cable 200 substantially decrease the amount of acrylate for a given number of optical fibers, thereby reducing a fuel loading of the cable 200 relative to a conventional indoor cable employing 250-micron-diameter fibers. In a particular embodiment wherein the cable 200 includes 384 optical fibers 212 having a 200-micron diameter, the cable jacket 202 can have a wall thickness of about 1.25 mm and the subunit jackets 211 can have thicknesses of about 0.225 mm. In such embodiment, the cable 200 has an overall outside diameter of about 12.0 mm. All else being equal, if such particular embodiment is modified to include fewer optical fibers 212 or a same number of optical fibers of a 165-micron diameter, the thickness of the cable jacket 202 can be less than 1.25 mm and the thickness of the subunits jackets 211 can be less than 0.225 mm.

In various embodiments, the optical fibers 212 of the subunits 210 can be 250-micron-diameter optical fibers. In such embodiments, the subunits 210 can each be configured to contain 16 of the optical fibers 212. In various other embodiments, the optical fibers 212 of the subunits 210 can be 165-micron-diameter optical fibers. In such embodiments, the subunits 210 can each be configured to contain 32 of the optical fibers 212.

Table 1 below shows the cross-sectional area occupied by various combinations of numbers of optical fibers in a 2.0 mm diameter subunit and their diameters:

TABLE 1
AREA OCCUPIED BY FIBERS WITHIN A 2.0 MM SUBUNIT

| Number of Fibers | 24 | 16 | 36 |
|---|---|---|---|
| Fiber OD (mm) | 0.2 | 0.25 | 0.165 |
| Fiber Area (mm²) | 0.754 | 0.785 | 0.770 |

Optical performance (e.g., signal attenuation) is expected to be similar across the different configurations set forth in Table 1 owing to the similar cross-sectional areas of the fibers in the different configurations.

In order to facilitate identifications of the optical fibers 212 at each end of the cable 200, the optical fibers 212 can be colored according to conventional coloring schemes used in the telecommunications industry. In an example, each of a first group of 12 of the optical fibers 212 can be uniquely identified by one of 12 colors. A next group of 12 of the optical fibers 212 in the subunit 210 can be ring-marked in addition to being colored. A third group of 12 of the optical fibers 212 in the subunit 210 can be double-ring-marked in addition to being colored in order to uniquely identify anywhere between 1 and 36 optical fibers 212 in a subunit 210.

In various embodiments, the optical fibers 212 in the subunits 210 can be loose optical fibers. In other words, the cable 200 can be a “loose-tube” type cable. In other embodiments, the optical fibers 212 in the subunits 210 can be ribbonized, such that a group of the optical fibers 212 is joined together in a same optical fiber ribbon. In such embodiments, the optical fibers 212 can be intermittently connected to form a flexible ribbon. In ribbonized embodiments, the subunits 210 can each include a plurality of flexible optical fiber ribbons. In some embodiments, some of the subunits 210 can include ribbonized optical fibers 212 whereas other of the subunits 210 can include loose optical fibers 212. In exemplary embodiments, one or more of the subunits 210 can include both ribbonized optical fibers 212 and loose optical fibers 212.

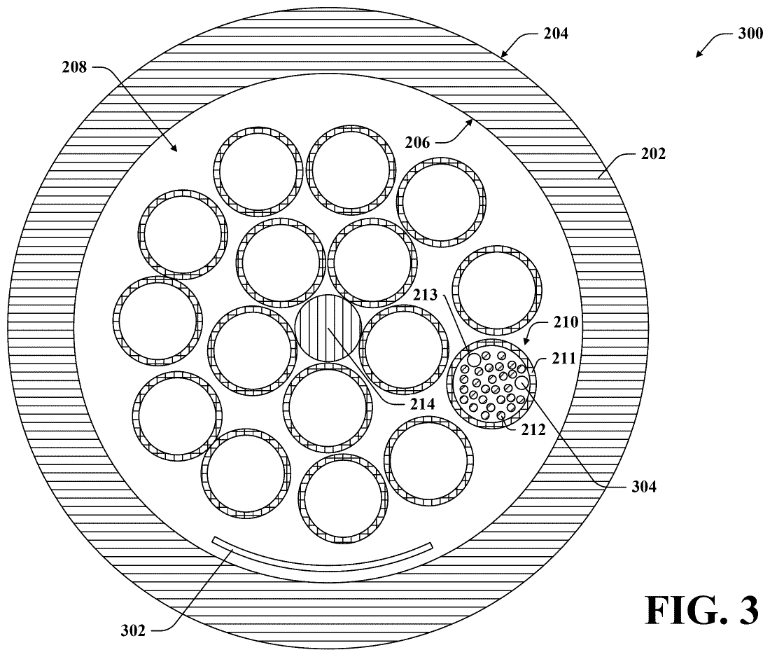

The cable 200 can further be configured for indoor/outdoor applications. By way of example, and referring now to FIG. 3, another exemplary cable 300 is illustrated, herein the cable 300 includes the cable jacket 202, the subunits 210, and the central member 214. The cable 300 can further include a water-blocking element 302, which is illustrated in FIG. 3 as a water-blocking tape. However, it is to be appreciated that the water-blocking element 302 can be or include water-blocking yarns or cords, or a water-blocking powder that is mechanically attached to (e.g., partially embedded in) the inside surface 206 of the cable jacket 202. Furthermore, in embodiments of the cable 300 configured for indoor/outdoor applications, each of the subunits 210 can include one or more water-blocking elements. In an exemplary embodiment, the subunit 210 includes a water-blocking element 304, shown as a water-blocking yarn or cord. In other embodiments, the subunits 210 can include a water-blocking powder mechanically attached to an interior of the subunit jacket 211 either in place of or in addition to a water-blocking yarn disposed within the subunit jacket 211.

Cables constructed according to the present disclosure are configured to exhibit a skew of less than 44 nanoseconds for a 2 km length of cable. An amount of skew is proportional to the length of the cable, and therefore a cable is designed to have a skew rate of less than or equal to 22 picoseconds (ps) per meter. In various embodiments, the cable 200 is configured to have a skew rate of less than or equal to about 11 picoseconds per meter. This requirement can be met by controlling the relative length difference between the various optical fibers 212 of the cable(s) 200, 300. These length differences can be controlled by maintaining a tight tolerance on the pay-off tension of the optical fibers 212 during manufacturing of the cable(s) 200, 300. In an exemplary embodiment, a payoff with either 12 or 24 optical fibers is calibrated to maintain a tolerance of 5.0 g tension about a target pay-off tension value.

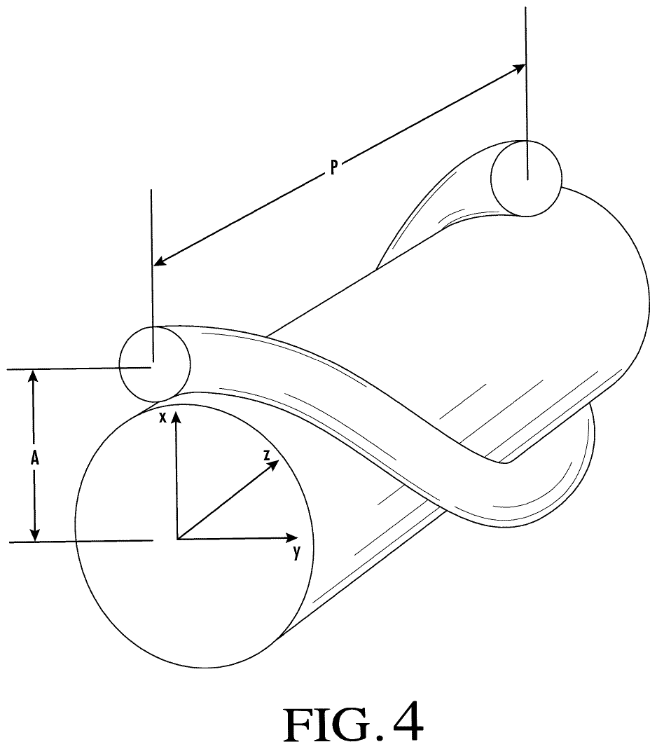

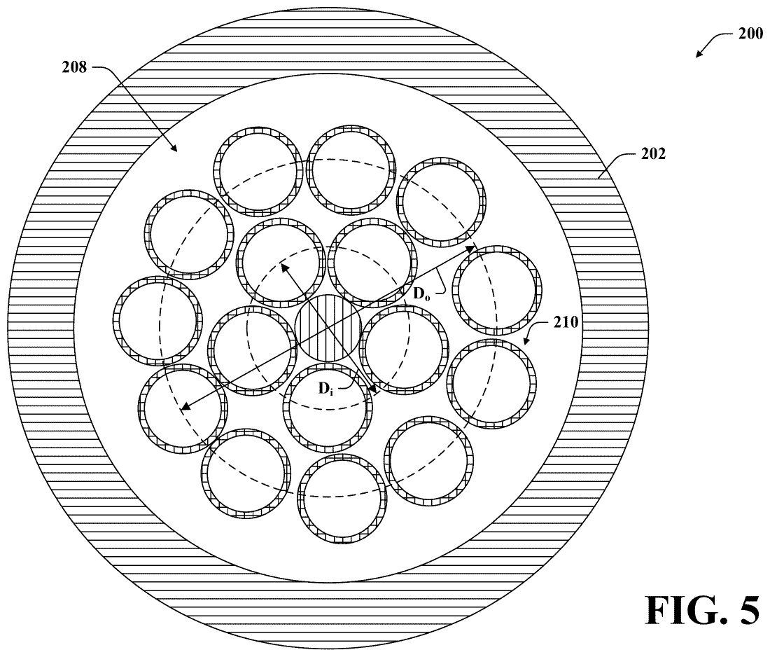

As the relative lengths of the optical fibers 212 are maintained to have a tight tolerance, the relative lengths of the subunits 210 are also tightly controlled. The relative lengths between the subunits 210 can be maintained by having a balanced helical length of the subunits. Two factors for helical length are the pitch, or lay length, and the pitch circle radius or diameter. FIG. 4 illustrates a depiction of the stranding parameters for a buffer tube stranded around a central member. The pitch radius is the distance from the center of the central member. The pitch radius is the distance from the center of the central member to the center of the stranded tube or subunit. The pitch diameter is two times the pitch radius. The pitch of a subunit 210 is its axial length (the z direction in FIG. 4) over which the subunit 210 makes one complete 360 degree wrap around the central member. The helix length is the ratio of the subunit length to the central member length and is given by Eq. 1

$${L}_{h e l i x} = \sqrt{1 + \frac{{( π D )}^{2}}{{P}^{2}}} \qquad Eq . 1$$

Where D is the pitch diameter, and p is the pitch of the subunit. The subunits 210 shown in FIGS. 2 and 3 are stranded in two layers. The pitch diameter of the inner layer is the diameter of the central member 214 plus the diameter of the subunit. In general, the pitch diameter for subunits 210 in a given layer of subunits 210 is the diameter of a circle going through the centers of such subunits. FIG. 5 illustrates the pitch diameters for the inner and outer layers of the subunits in the exemplary cable 200 that has two layers of the subunits 210. Low skew is obtained when the helix of the inner layer of subunits matches the helix of the outer layer. Let Dᵢ and pᵢ be the diameter and pitch for the inner layer of subunits and Dₒ and pₒ be the diameter and pitch for the subunits in the outer layer. Setting the helix length of the inner layer of the subunits 210 and the outer layer of the subunits 210 to be equal yields Eq. 2:

$$\sqrt{1 + \frac{{( π {D}_{i} )}^{2}}{{P}_{i}^{2}}} = \sqrt{1 + \frac{{( π {D}_{o} )}^{2}}{{P}_{o}^{2}}} \qquad Eq . 2$$

where Dᵢ and pᵢ are the diameter and pitch for the inner layer of the subunits 210 and Dₒ and pₒ are the diameter and pitch for the outer layer of the subunits 210 shown in FIG. 5. Eq.2 may be simplified to write

$${D}_{i} / {p}_{i} = {D}_{0} / {p}_{o} \qquad Eq . 3$$

The stranding parameters Dᵢ and pᵢ for the inner-most layer of the subunits 210 can be selected according to cable bending requirements or cable attenuation requirements. Then the parameters for the second and any subsequent layers of the subunits 210 may be determined according to Eqs. 2 and 3. Following these procedures results in a low skew cable that meets the skew requirements set forth in IEEE 802.3. The pitch diameter increases between the first layer of the subunits 210 and the second layer of the subunits 210. The pitch of the outer layer is increased relative to the pitch of the inner layer proportionally to the increase in diameter from the inner layer to the outer layer to maintain a constant helix length.

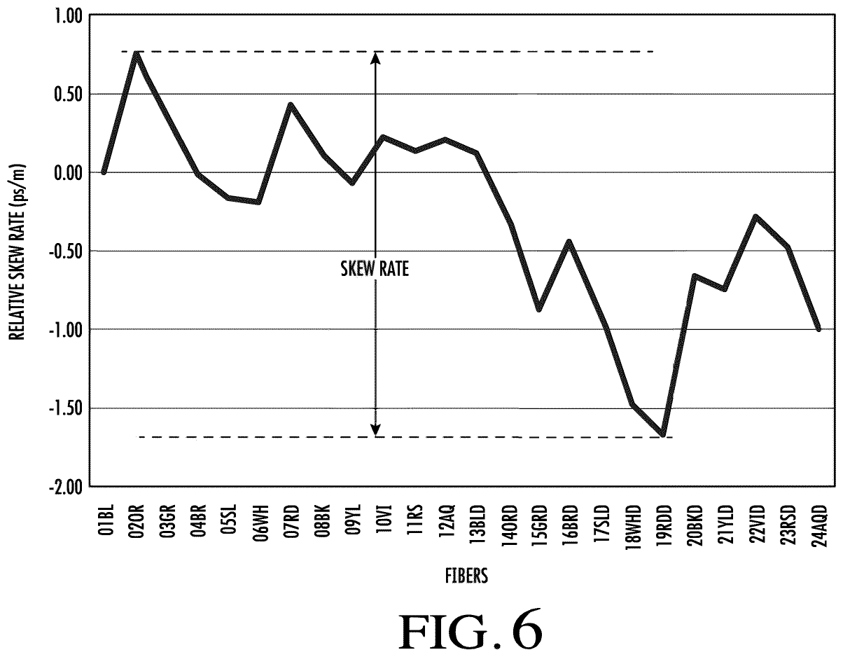

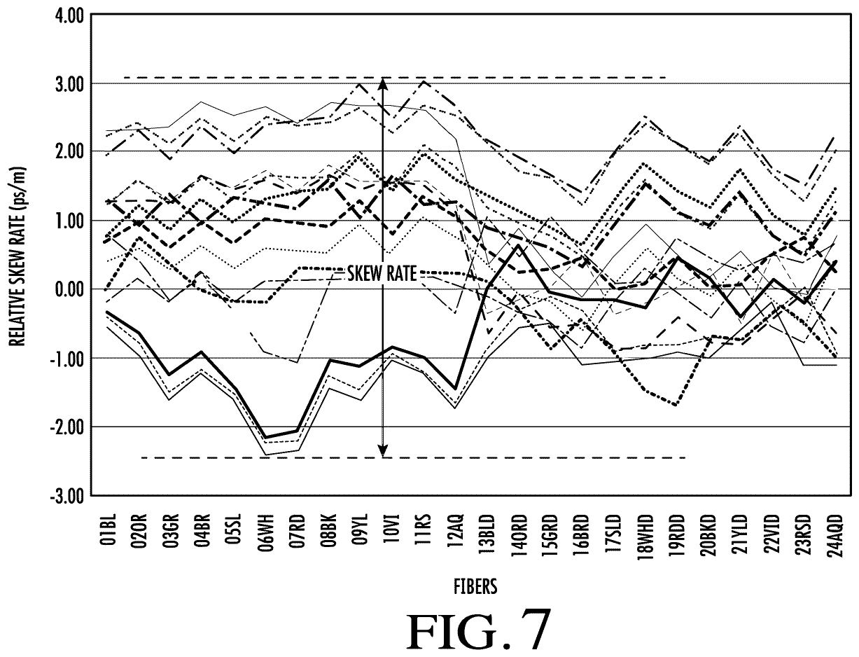

FIG. 6 shows the experimental results of a skew rate measurement in a 24-fiber subunit of a 384-fiber embodiment of the cable 200 illustrated in FIG. 2. The measured skew rate was 2.42 ps/m. The relative skew rates for all 16 subunits within the 384-fiber test cable are shown in FIG. 7. The maximum skew rate between any two fibers in the cable was 5.44 ps/m.

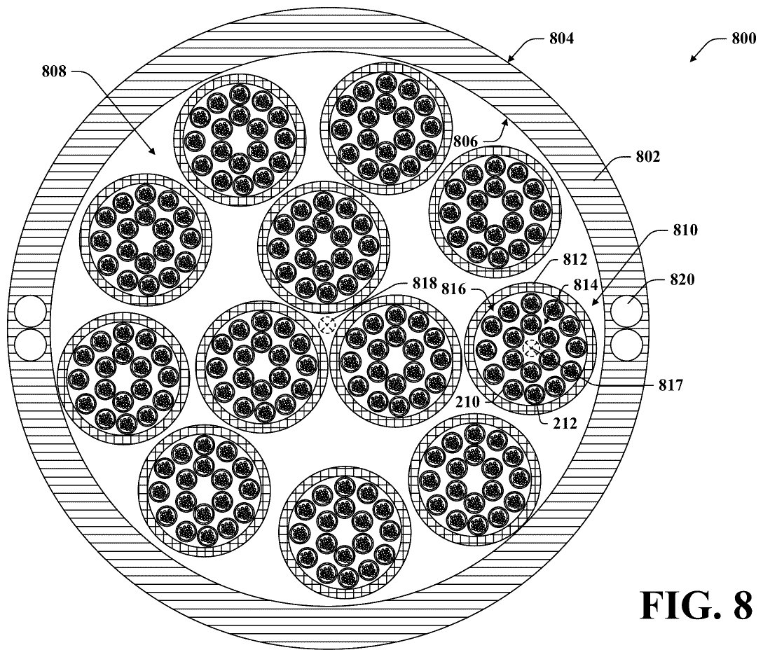

FIG. 8 is a cross-sectional view of another exemplary optical fiber cable 800. The cable 800 includes a cable jacket 802 having an outer surface 804 and an inner surface 806. The inner surface 806 of the cable 800 defines an interior region 808 that is contained by the cable jacket 802. The cable 800 further includes a plurality of the subunits 210. In particular, the cable 800 includes bundles 810 of the subunits 210, wherein each of the bundles 810 respectively comprises a bundle jacket 812 and a plurality of the subunits 210 disposed within the bundle jacket 812. The bundle jacket 812 can be formed from an extruded layer of any of various materials such as, but not limited to, LLDPE, LDPE, an LSZH material, an FRNC material, or an FRPE material. In exemplary embodiments, the bundle jacket 812 has a thickness of less than or equal to 300 microns, or more particularly greater than or equal to 30 microns and less than or equal to 300 microns, or still more particularly greater than or equal to 40 microns and less than or equal to 250 microns. The bundles 810, like the subunits 210 themselves, are sufficiently flexible that the cable jacket 802 and other elements of the cable 800 can be stripped away from a single subunit bundle 810 and the subunit bundle 810 independently routed, such as to another portion of a data center. The bundle jackets 812 can include various fire-retardant fillers such as metal hydroxides and/or borates.

The exemplary optical fiber cable 800 depicted in FIG. 8 includes 12 of the subunit bundles 810, each containing 18 subunits 210, wherein each of the subunits 210 includes 16 optical fibers 212, such that the cable 800 includes 3,456 of the optical fibers 212. However, it is to be appreciated that the optical fiber cable 800 incorporating the subunit bundles 810 can be configured to include any of various numbers of optical fibers 212 per subunit 210, any of various numbers of subunits 210 per bundle 810, and any of various numbers of the bundles 810.

The cable 800 can be configured as a low-skew cable. For instance, each of the subunits 210 of the cable 800 can be manufactured using optical fiber payoffs that are calibrated to maintain a tolerance of ±5 g tension from a target value.

Furthermore, within each of the subunit bundles 810, the subunits 210 can be stranded with a balanced helical length, maintaining a tight tolerance among the lengths of the subunits 210 within each bundle 810. The subunits 210 within each bundle 810 can be stranded in two layers, an inner layer 814 and an outer layer 816. The helix lengths of the subunits 210 of the inner layer 814 and the outer layer 816 within each of the bundles 810 can be set to be approximately equal according to Eqs. 2 and 3 above.

Similarly, the bundles 810 themselves can be stranded with balanced helical length such that lengths of the bundles 810 are maintained to a tight tolerance, in accordance with Eqs. 2 and 3 above. Accordingly, the cable 800 is configured to exhibit a skew rate of less than 22 picoseconds per meter for any of the fibers 212 for a 2 km length of the cable 800, or more particularly a skew rate of less than 11 picoseconds per meter.

It is to be appreciated that while the subunits 210 of the cables 200, 300 are shown as being stranded about a central member 214, the cable 800 does not have a central member. Thus, the subunits 210 of each of the subunit bundles 810 are instead stranded about a central axis 817 of their respective subunit bundle 810. Similarly, the subunit bundles 810 themselves are stranded about a central axis 818 of the cable 800 (as shown, extending into and out of the page in FIG. 8). It is therefore to be understood that where Eqs. 2 and 3 and their accompanying description reference a central member, such references may instead be taken to refer to the central axis of a cable (e.g., the central axis 818 of cable 800) when the cable does not include a central member.

In some embodiments, the cable 800 can include strength members 820 that are embedded in the cable jacket 802. Such embedded strength members 820 can provide resistance to thermal contraction of the cable jacket 802.

What has been described above includes examples of one or more embodiments. It is, of course, not possible to describe every conceivable modification or alteration of the above systems, devices, or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An optical fiber cable, comprising;
a cable jacket;
a subunit disposed within the cable jacket, the subunit comprising:
a subunit jacket having an outer diameter between 0.9 mm and 2.6 mm; and
a plurality of optical fibers disposed within the subunit jacket;
wherein the optical fiber cable is characterized by a maximum skew of less than or equal to 44 nanoseconds for a 2-km length of the optical fiber cable.

2. The optical fiber cable of claim 1, the subunit being a first subunit, the optical fiber cable further comprising:
a plurality of subunits, wherein the plurality of subunits are stranded to have balanced helical lengths, such that the maximum skew is less than or equal to 44 nanoseconds for a 2-km length of the optical fiber cable.

3. The optical fiber cable of claim 2, wherein the plurality of subunits is a first plurality of subunits, the optical fiber cable further comprising:
a second plurality of subunits, wherein the second plurality are stranded around a same axis as the first plurality of subunits such that the second plurality of subunits surrounds the first plurality of subunits.

4. The optical fiber cable of claim 3, wherein helical lengths of the second plurality of subunits are balanced with helical lengths of the first plurality of subunits.

5. The optical fiber cable of claim 4, wherein the first plurality of subunits are characterized by a first helical length L_{helix inner} defined by:
$${L}_{helix inner} = \sqrt{1 + \frac{{( π {D}_{i} )}^{2}}{{P}_{i}^{2}}}$$
where Dᵢ is a pitch diameter of the first plurality of subunits and pᵢ is a pitch of the first plurality of subunits.

6. The optical fiber cable of claim 5, wherein the second plurality of subunits are characterized by a second helical length L_{helix outer} defined by:
$${L}_{helix outer} = \sqrt{1 + \frac{{( π {D}_{o} )}^{2}}{{P}_{o}^{2}}}$$
where Dₒ is a pitch diameter of the second plurality of subunits and pₒ is a pitch of the second plurality of subunits, and wherein the first helical length and second helical length are approximately equal such that the maximum skew is less than or equal to 44 nanoseconds for a 2-km length of the optical fiber cable.

7. The optical fiber cable of claim 1, the subunit being a first subunit, the optical fiber cable further comprising:
a subunit bundle, the subunit bundle comprising:
a plurality of subunits that includes the first subunit; and
a bundle jacket that surrounds the plurality of subunits.

8. The optical fiber cable of claim 7, wherein the bundle jacket comprises a fire-retardant polymeric material.

9. The optical fiber cable of claim 7, wherein the plurality of subunits in the subunit bundle are stranded to have balanced helical lengths.

10. The optical fiber cable of claim 9, wherein the plurality of subunit in the subunit bundle are stranded around a central axis of the subunit bundle.

11. The optical fiber cable of claim 9, wherein the subunit bundle is a first subunit bundle, the optical fiber cable further comprising:
a plurality of subunit bundles each respectively comprising:
a plurality of subunits that are stranded to have balanced helical lengths; and
a bundle jacket that surrounds the plurality of subunits;
wherein the first subunit bundle is included in the plurality of subunit bundles.

12. The optical fiber cable of claim 11, wherein the plurality of subunit bundles are stranded around a central axis of the optical fiber cable to have balanced helical lengths.

13. The optical fiber cable of claim 11, wherein each of the cable jacket, the subunit jacket, and the bundle jackets of the plurality of subunit bundles are formed from a material that comprises at least one fire-retardant additive.

14. A cable assembly, comprising:
the cable according to claim 1; and
a connector adapted to accommodate the subunit, wherein the connector is attached to the subunit such that the connector is configured to connect the optical fibers of the subunit to a connector receptacle.

15. A method for making an optical fiber cable, comprising:
paying off a plurality of optical fibers;
forming a subunit by extruding a subunit jacket around the plurality of optical fibers, wherein the subunit jacket has an outer diameter between 0.9 mm and 2.6 mm; and
extruding a cable jacket around the subunit such that the subunit is disposed within the cable jacket, wherein the optical fibers are payed off so that lengths of the optical fibers are approximately equal and the optical fiber cable is characterized by a maximum skew of less than or equal to 44 nanoseconds for a 2-km length of the optical fiber cable.

16. The method of claim 15, wherein the plurality of optical fibers are each payed off with a ±5.0 g tension tolerance from a pay-off tension target value.

17. The method of claim 15, comprising:
forming one or more additional subunits that each include a respective subunit jacket and respective plurality of optical fibers, thereby forming a plurality of subunits that includes the subunit and the one or more additional subunits; and
stranding the plurality of subunits around a common axis such that the plurality of subunits have balanced helical lengths.

18. The method of claim 17, wherein stranding the plurality of subunits around the common axis comprises stranding the plurality of subunits around a same central strength member.

19. The method of claim 17, wherein the plurality of subunits is a first plurality of subunits, the method further comprising:
forming a second plurality of subunits; and
stranding the second plurality of subunits around the first plurality of subunits such that helical lengths of the second plurality of subunits are balanced with helical lengths of the first plurality of subunits.

20. The method of claim 17, further comprising:
forming a subunit bundle by extruding a bundle jacket around the plurality of subunits; and
stranding the subunit bundle with one or more additional subunit bundles such that the subunit bundle and the one or more additional subunit bundles have balanced helical lengths.
